(19) United States
(12) Patent Application Publication
(10) Pub. No.: US 2018/0096298 A1
(43) Pub. Date: Apr. 5, 2018

(54) SELF-RETURN

(71) Applicant: Wal-Mart Stores, Inc., Bentonville, AR (US)

(72) Inventors: Emmanuel Twizeyimana, Bentonville, AR (US); Bryan Nathaniel Pew, Austin, TX (US); Hoang-Anh Au, Van Buren, AR (US); David Isauro Medina Reyna, Rogers, AR (US); Julius Moore Stallworth, Centerton, AR (US)

(21) Appl. No.: 15/711,368

(22) Filed: Sep. 21, 2017

Related U.S. Application Data
(60) Provisional application No. 62/403,255, filed on Oct. 3, 2016.

(51) Int. Cl. G06Q 10/08; G06Q 20/04; G06Q 20/10; G06Q 20/34; G06Q 20/32; G06Q 30/06; G06F 3/0484; G06K 9/20

(52) U.S. Cl. CPC G06Q 10/0837; G06Q 20/04; G06Q 20/102; G06K 9/20; G06Q 20/32; G06Q 30/0643; G06F 3/0484; G06Q 20/34

(57) ABSTRACT

A system is described that assists a customer in efficiently returning items to a commercial entity, such as a retail store, for a refund. It employs an App running on the customer's mobile device that scans a receipt to acquire return information, receives input from the customer and transmits it to a backend computing device of the commercial entity. The backend computing device receives the return information from the mobile device, and provides an image associated with the return to the mobile device. When the customer arrives at the customer service area of the retail store with the item to return, the backend system reads the image displayed by the mobile device, recalls the return record and uses it for the refund information. If the customer has not violated any return rules, and the item is acceptable, then the cost of the item is refunded to the customer.

### RELATED APPLICATIONS

This application claims the benefit of U.S. Provisional Patent No. 62/403,255, filed Oct. 3, 2016, entitled “Self-Return” the contents of which are incorporated by reference herein in their entirety.

### FIELD

Aspects of the present invention relate to a system for returning an item to a retail store for a refund, and more specifically to a system for returning an item to a retail store for a refund that is more efficient than current systems.

### BACKGROUND

Customers occasionally purchase the products at retail stores that do not meet their needs. Retail stores allow the customer to return the product for a refund. This typically requires the customer driving to the store with the product, standing in line waiting for an employee of the store, typically a customer service representative, who requests information from the customer. Returns and exchanges require several steps. The customer service representative must get information from the customer before the return can be processed. This includes the name and address of the person returning the product, the sale price of the product, the amount of tax paid, the reason for return, and other information. Currently, this process is manual and very slow. Since much of the information is manually entered, there is a chance that the data is not input accurately, especially if the customer service representative is being rushed.

During peak shopping seasons, the problem gets worse since the line for customer service becomes very long and the customers tend to get frustrated by the long wait.

This invention will improve customer experience when returning products. The Self-return process will also save time for associates at the store. This way, they can better allocate their associates to different tasks.

Another problem is that the current systems do not have a history of the customer's return history. This can lead to repeated returns at various different stores and fraud.

Currently, there is a need for a system which quickly and accurately receives the required information for a product return, checks for repeated returns and fraud, and provides the customer with a return history.

### BRIEF SUMMARY

According to aspects of the present inventive concepts there is provided an apparatus and method as set forth in the appended claims. Other features of the inventive concepts will be apparent from the dependent claims, and the description which follows.

The current invention may be embodied as a method of efficiently returning an item for a refund at a return location of a commercial entity by remotely acquiring information from a mobile device relating to the return of the item, storing the acquired information as a return record in a backend computing device, associating a unique identification code with the return record, and sending a unique identification code to the mobile device. Later, when the mobile device is at the return location, the system then reads the unique identification code from the mobile device. The system then recalls the return record associated with the unique identification code. The method continues by scanning a product identification code on the item, verifying that the product identification code is related to the return record, and refunding a cost of the item if the product identification code relates to the return record.

The current invention may also be embodied as a system for efficiently returning an item to a commercial entity for a refund having a mobile device adapted to scan a receipt 3, scan a product identification code on the item, receive information from the customer 5, receive a unique identifier code and an image both associated with a return record.

The mobile device is adapted to display the associated image to an image acquisition device of the backend computing device.

The system also includes a receipts database having a plurality of prestored receipts and purchase transaction records, and a returns database adapted to store information about item returns. The backend computing device includes a backend processor coupled to the image acquisition device and the mobile device. The backend processor is adapted to read the scan of the receipt 3 to acquire a purchase transaction number, search the receipts database to find a purchase transaction record in the receipts database associated with the scanned receipt, read the scan of the code of the item and identify if the item is listed in the purchase transaction record. If the item is found in the purchase transaction record, storing the information received from the customer in a return record in the returns database. The backend processor is also adapted to scan the image on the customer's mobile device when it is sensed nearby, associate the scanned image with the unique identifier code and the return record, use the information in the return record for the refund, and authorize refund of funds if the item is acceptable.

The current invention may also be embodied as a system that assists in efficiently returning items to a commercial entity for a refund having a mobile device adapted to receive return information provided to it, transmit the return information to a remote computing device associated with the commercial entity, and display images provided to it.

It also includes a backend computing device adapted to receive the return information from the mobile device, associate a unique identification code and image with the return information, store the received return information, unique identification code, and image as a return record, and notify the mobile device that the unique identification code and the image are associated with the return record. The backend computing device also functions to read the image displayed on the mobile device, associate the image with the unique identifier code and return record, scan a product identification code on the item to identify the item, verify that this item is associated with the return record; and refund the cost of the item.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale; emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIGS. 1 and 2 are simplified block diagrams illustrating the major components of a system according to one embodiment of the present invention.

FIG. 3A is a flowchart according to one embodiment of the present invention, illustrating the major steps of a method that can be implemented remotely.

FIG. 3B is a flowchart according to one embodiment of the present invention, illustrating the steps of a method that that are implemented when the customer does not have a receipt.

FIG. 4 is a flowchart according to one embodiment of the present invention, illustrating the major steps of a method that are implemented at a location of the commercial entity.

### DETAILED DESCRIPTION

The current invention describes a system that will allow a customer to begin return process of an item purchased from a commercial entity, such as a retail store, from the comfort of their home. The process will be initiated from a mobile device and not from inside a store. An application (“App”) is provided to the customer, such as by downloading it from a conventional download site.

The mobile device running the App will guide the customer through the process needed to complete the return.

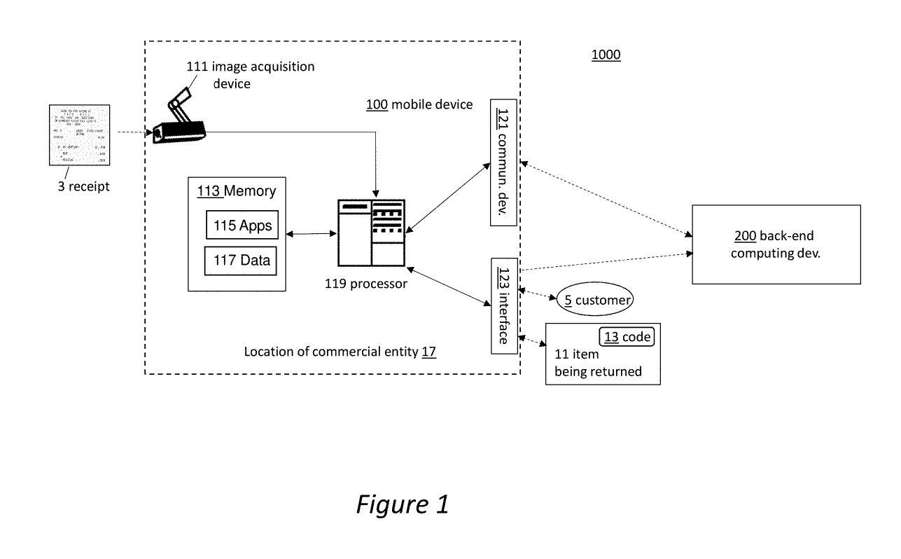

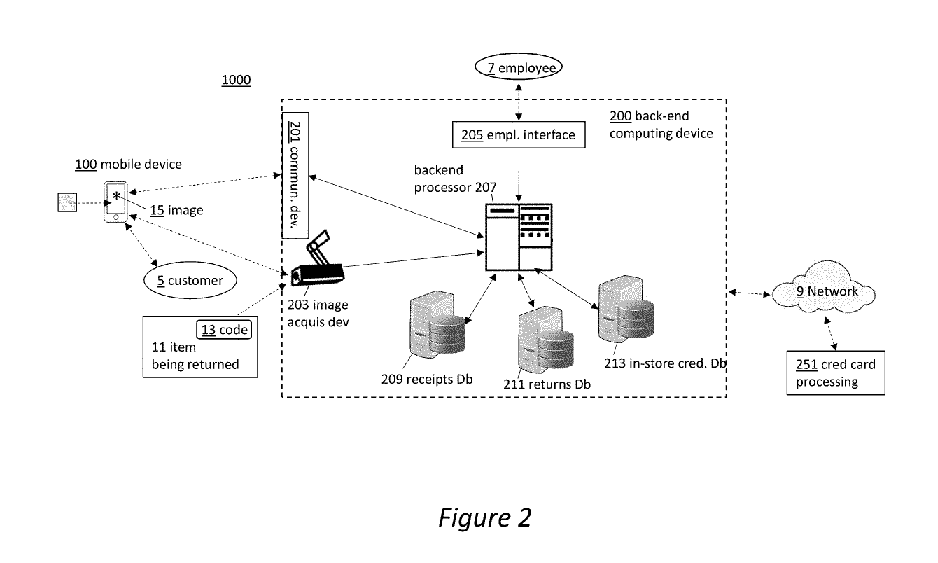

FIGS. 1 and 2 are simplified block diagram illustrating the major components of a system according to one embodiment of the present invention.

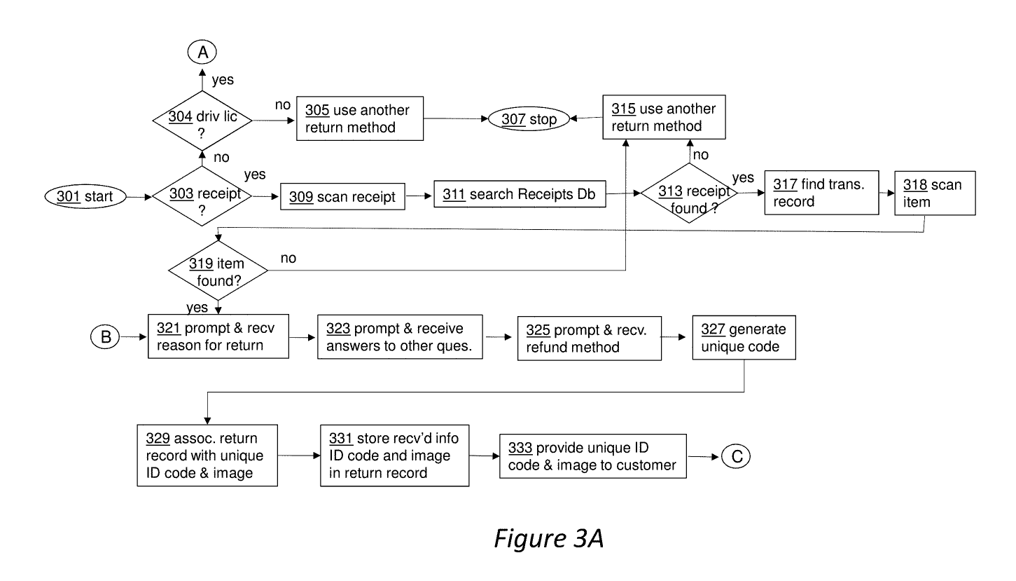

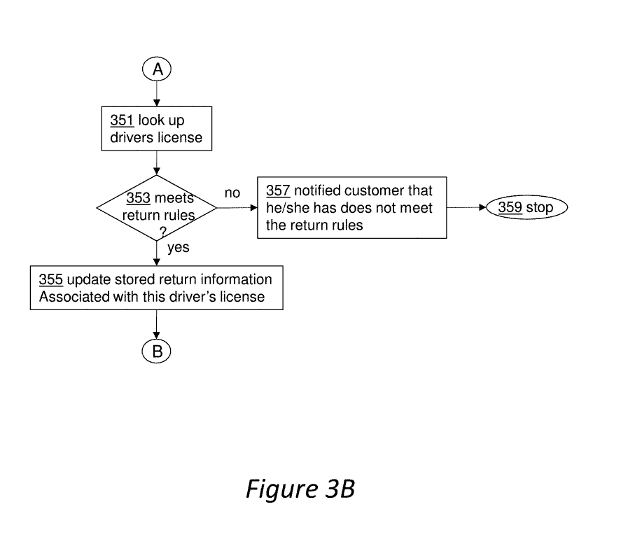

FIG. 3A is a flowchart according to one embodiment of the present invention, illustrating the major steps of a method that can be implemented remotely.

The structure and functioning of an embodiment of the current invention will now be described in connection with FIGS. 1 and 3A.

The process of the current invention begins at step 301 of FIG. 3A. In step 303, processor 119 communicates with customer 5 through an interface 123. It is determined if there is a receipt for the purchase of item 11 that is intended to be returned for a refund. If there is no receipt (“no”) then step 304 is processed next.

In step 303 it is determined if customer 5 has a driver's license. If customer 5 does not have a driver's license (“no”), then in step 305 an alternative method is used to return item 11. The alternative method may be a conventional in-person return of item 11 to a customer service representative of the retail store. The process then stops in step 307.

In step 304, if customer 5 has a driver's license (“yes”), then processing continues as indicated at marker “A” in FIG. 3B to step 351.

In step 303, if the customer 5 has a purchase receipt for item 11 (“yes”), then the receipt is scanned in step 309. This may be scanned by an image acquisition device 111 of mobile device 100; typically this would be the mobile device of customer 5. Therefore, when read receipt 3 is scanned by image acquisition device 111 the information passes to processor 119 which is running an executable application (“App”) that was previously downloaded and stored in memory 113 along with support data 117. This app has the ability to find and decode barcodes, QR codes, or other optical symbols which may be used to encode information. In this embodiment, the code on receipt 3 indicates a purchase transaction number. This purchase transaction numbers sent by processor 119 through communication device 121 to backend computing device 200.

FIG. 2 shows a more detailed block diagram of backend computing device 200. In FIG. 2, the purchase transaction number passes through the communication device 201 to backend processor 207.

In step 311, backend processor 207 searches receipts database 209 to identify a purchase transaction record associated with the purchase transaction number of receipt 3.

In step 313 is determined if the receipt has been found in the receipts database 209. If it has not been found (“no”), then step 315 is performed and another method is used to return item 11. This branch of the process stops at step 307.

In step 317, if a receipt and its purchase transaction number are found (“yes”), then the purchase transaction record associated with the purchase transaction number is acquired and stored.

In step 318, a product identification code on item 11 is scanned to identify the item 11.

In step 319 is determined if item 11 is referenced in the purchase transaction record. If the item 11 is not referenced in the purchase transaction record (“no”), then step 315 is performed indicating that another return method must be used. This branch of the process also ends at step 307.

In step 319 if item 11 is found in the purchase transaction record (“yes”), in step 321 processor 119 communicates with customer 5 through interface 123 to prompt them and receive a reason for return of item 11.

In step 323 processor 119 prompts customer 5 through interface 123 requesting other information relating to the return of item 11. The responses from customer 5 to these prompts pass through interface 123 to processor 119 which communicates them to backend computing device through communication device 121.

In step 325, processor 119 running the app prompts customer 5 through interface 123 requesting a method to refund the cost of item 11. For example, this may be a refund to a credit card, a refund by updating in-store credit, or by providing cash to customer 5.

The responses are received from customer 5 through interface 123 to processor 119 which passes them to backend computing device 200 through communication device 121.

Once all the return information has been provided, in step 327, backend processor 207 creates a unique identification code, and image.

In step 329 backend processor 119 associates to return information with the unique ID code in the image.

In step 331, backend processor 207 stores the return information, unique ID code, and image as a return record in returns database 211. In step 333, backend processor 207 provides mobile device 100 with the unique ID code and image, which may be a unique optical pattern, such as a bar code, or QR code.

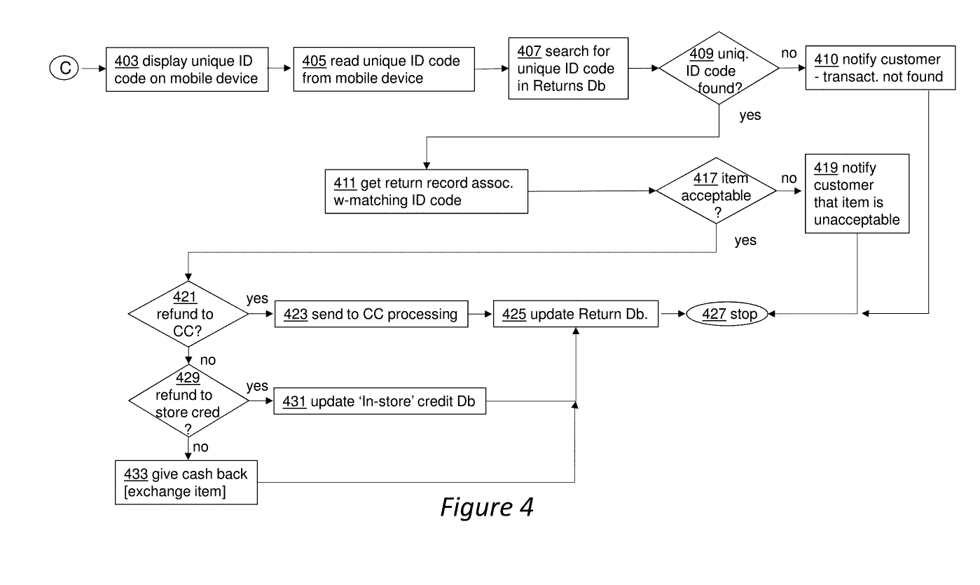

Processing then continues at step 403 of FIG. 4 as indicated by markers “C”.

FIG. 3B is a portion of a flowchart which shows the major steps in processing a return of item 11 when customer 5 does not have a receipt. This functioning will be described in connection with FIGS. 1, 2 and 3B.

If customer 5 indicated in step 304 that he/she has a driver's license then the driver's license information is acquired from customer 5 through interface 123 to processor 119 and sent to backend computing device 200 through communication device 121.

In step 357, backend processor 207 then searches the returns database 211 with the driver's license information to find previous history of customer 5. It is then determined if a return of item 11 by customer 5 would be a violation of any of the commercial entities rules. These rules may include, but are not limited to, a restricting the number of returns that can be made by a single customer within a predetermined period of time, previous fraud, or any other fraudulent transactions.

In step 353, if it would violate one of the return rules for customer 5 if the return of item 11 is allowed (“no”), then in step 357 the customer 5 is notified by processor 119 acting through interface 123 that the return of item 11 would violate the return rules for commercial entity 17.

If a return of item 11 is allowed (“yes”), then the stored return record associated with the driver's license number of customer 5 is updated. In step 355.

Processing then continues at step 321 of FIG. 3A shown by marker “B”.

This completes portion of the process that can be done remotely. Customer 5 is now bringing item 11 and mobile device 100 to a location of the commercial entity 17. For example, if commercial entity 17 is a retail store, then the return location may be a customer service desk.

FIG. 4 is a flowchart according to one embodiment of the present invention, illustrating the major steps of a method that are implemented at a location within commercial entity 17.

The functioning of this portion of the return process will be described with reference to FIGS. 1, 2 and 4. When the customer 5 arrives at the location of the commercial entity 17 with mobile device 100 and the item 11 to be returned, mobile device 100 displays the image that is associated with the stored return transaction record in step 403.

In step 405, image acquisition device 203 reads the image 15 on mobile device 100 that is associated with the unique identification code. This image 15 is provided to backend processor 207 which converts it to its corresponding unique identification code.

Backend processor 207 uses the unique identification code to search returns database 211 to find the return record which has previously been stored there in step 407.

In step 409 if the unique identification code is not found (“no”), then the customer 5 is notified in step 410 in processing of this branch of the method stops at step 427.

In step 409, if the unique identification code is found (“yes”), then the return record associated with the unique identification code is used to implement the refund.

In step 417 it is determined if the item 11 is acceptable. For example, it is determined if the item is the same item that was listed in the purchase transaction record and receipt 3. It can also be that the item is unacceptable because it is missing parts. It can also be that the item is unacceptable if it is broken or damaged.

If the item is determined to be unacceptable (“no”), then the customer is notified in step 419 and this branch of the process stops at step 427.

If in step 417, it is determined that the item is acceptable (“yes”), then the proper refund is implemented. If customer 5 had purchased item 11 on a credit card and in step 421 requests the refund to be credited to his/her credit card (“yes”), then in step 423, a credit for the purchase cost of item 11 is sent from backend computing device 200 through a network 9 such as the Internet, to a credit card processing entity 251 which updates the credit card account of customer 5 in step 425. This branch of the return process then stops at step 427.

If customer 5 has not chosen to have a refund on the credit card in step 421 (“no”), then it is determined if the refund is to be made by in-store credit. If it is (“yes”), then in step 431, backend processor 207 updates the customer's in-store credit record in the in-store credit database 213. Processing then continues at step 425 and ends at step 427.

In step 429 if the refund is not to be made to store credit (“no”), then cash is given to customer 5. Processing then continues to step 425 to update the return database in the process then stops at step 427.

The system 1000 will maintain a customer profile for each customer 5 that makes a return in the returns database 211 with detailed information about each return. This history of returns can be displayed to the customer 5 through mobile device 100 to provide a visual record of return status updates on the completion and/or progress of returns. Example status updates would include: “Processing Cash Back”, “Ready for drop off”, “In Progress”, ‘Money has been deposited to your account” among others.

In an alternative embodiment of the current invention, executable code would be created to run the return process on kiosk machines similar to the self-checkouts that we have in the stores. These machines may be located in various locations, including the customer service area of the commercial entity. This allows convenient return of the item 11 to the commercial entity. When at the self-return machine, the customer will be required to scan his/her receipt, the product's barcode, and answer a few questions related to the return. There will be an associate assigned to several machines to do any final approval, if needed.

Although a few examples have been shown and described, it will be appreciated by those skilled in the art that various changes and modifications might be made without departing from the scope of the invention, as defined in the appended claims.

What is claimed is:

1. A method of efficiently returning an item for a refund at a return location of a commercial entity, comprising the steps of:
acquiring information from a remote mobile device relating to the return of the item;
storing the acquired information as a return record in a backend computing device;
associating a unique identification code with the return record;
sending a unique identification code to the mobile device;
reading the unique identification code from the mobile device at the return location at a later time;
recalling the return record associated with the unique identification code;
scanning a product code on the item;
verifying that the product code is related to the return record; and
refunding a cost of the item if the product code relates to the return record.

2. The method of claim 1 wherein the step of acquiring information comprises the steps of:
making a connection between the backend computing device to the mobile device;
obtaining a purchase transaction number for the item from the mobile device;
searching the backend computing device to acquire a purchase transaction record relating to the identified purchase transaction number.

3. The method of claim 2 wherein the step of obtaining the purchase transaction for the item comprises the steps of:
scanning a receipt to identify a purchase transaction number;
searching a receipt database to identify a purchase transaction record associated with the receipt and purchase transaction number;
scanning a product identifier code on the item to identify the item being returned; and
verifying that the item is found in the purchase transaction record.

4. The method of claim 1 wherein the step of reading the unique identifier code comprises the steps of:
reading an image displayed on the mobile device by the backend computing device, and finding the unique identifier code associated with the image.

5. The method of claim 4 wherein the image is one of a QR code, barcode, and other optical code associated with the unique identifier code.

6. The method of claim 1 wherein the step of refunding the cost of the item to the customer comprises the step of:
crediting a credit card.

7. The method of claim 1 wherein the step of refunding the cost of the item to the customer comprises the step of:
updating an in-store credit account.

8. The method of claim 1 wherein the step of refunding the cost of the item to the customer comprises the step of:
refunding cash.

9. The method of claim 1 wherein the step of acquiring information comprises the steps of:
receiving return information relating to the return of the item from the mobile device at a remote location with respect to that of the commercial entity; and
storing the received return information as a return record in the backend computing device associated with the commercial entity.

10. A system for efficiently returning an item to a commercial entity for a refund comprising:
a mobile device adapted to:
scan a receipt;
scan a product code on the item;
receive return information from the customer;
store the return information as a return record in a remote computing device associated with the commercial entity;
receive a unique identifier code and an image both associated with a return record;
display the associated image;
an image acquisition device of a backend computing device is adapted to optically scan images and objects;
a receipts database having a plurality of prestored receipts and purchase transaction records;
a returns database adapted to store information about item returns as return records;
a backend processor coupled to the image acquisition device and the mobile device adapted to:
receive the scan of the receipt to acquire a purchase transaction number;
search the receipts database to find a purchase transaction record in the receipts database associated with the scanned receipt;
scan a product identification code on the item to identify if the item;
verify that the item is listed in the purchase transaction record;
if the item is found in the purchase transaction record, storing the information received from the customer in a return record in the returns database;
scan the image on the customer's mobile device;
find the unique identifier code associated with the scanned image;
find the return record using the unique identifier code;
use the information in the return record for a refund, if the item is acceptable.

11. The system of claim 10, further comprising:
an in-store credit database having prestored in-store credit balances coupled to the backend processor, allowing the backend processor to provide a refund as an in-store credit database.

12. The system of claim 10, further comprising:
a credit card processing interface linking the backend processor to credit card companies to provide a refund to a credit card account.

13. The system of claim 10, wherein the image acquisition device of backend computing device is located at the commercial entity.

14. A system that assists in efficiently returning items to a commercial entity for a refund, comprising:
a mobile device adapted to:
receive return information provided to it,
transmit the return information to a remote computing device associated with the commercial entity, and
display images provided to it;
a backend computing device adapted to:
receive return information from the mobile device;
associate a unique identification code and image with the return information;
store the received return information, unique identification code, and image as a return record;
notify the mobile device that the unique identification code and the image are associated with the return record;
read the image displayed on the mobile device,
associate the image with the unique identifier code and return record;
scan a product identification code on the item to identify the item;
verify that this item is associated with the return record; and
refund the cost of the item.

15. The system of claim 14 wherein the mobile device further comprises:
an image acquisition device for scanning a receipt;
a communication device adapted to communicate with the back -end computing device;
a processor coupled to the image acquisition device and the communication device, adapted to receive the scan from the image acquisition device and provide it to a communication device to communicate it to the backend computing device.

16. The system of claim 14, wherein the backend computing device further comprises:
a receipts database having a plurality of prestored purchase transactions;
a communication device adapted to communicate with the mobile device;
a processor coupled to the communication device and the receipts database adapted to search the receipts database to find a purchase transaction which matches the scanned receipt.

17. The system of claim 14, further comprising:
an employee interface that allows an employee to enter information into the backend computing device.

18. The system of claim 14, further comprising:
an in-store credit database having prestored in-store credit balances coupled to the backend processor, allowing the backend processor to provide a refund to the in-store credit database.

19. The system of claim 14, further comprising:
a credit card processing interface linking the backend processor to credit card companies to provide a refund to a credit card account.

20. The system of claim 14, wherein the backend computing device is further adapted to provide a real-time status of the return of the item through the mobile device.
